(19) United States
(12) Patent Application Publication
(10) Pub. No.: US 2013/0000679 A1
(43) Pub. Date: Jan. 3, 2013

(54) MULTI-CHANNEL DE-APPLICATOR

(76) Inventors: Manuel PARRA-GARCIA, Tempe, AZ (US); Christopher R. SCHROEDER, Chandler, AZ (US); Joaquin AGUILAR-SANTILLAN, Gilbert, AZ (US); Jerome L. GARCIA, Chandler, AZ (US)

(21) Appl. No.: 13/175,679

(22) Filed: Jul. 1, 2011

(51) Int. Cl. B08B 5/04; B08B 3/04

(52) U.S. Cl. 134/21; 15/320

(57) ABSTRACT

An apparatus to clean an electronic device may include a head structure having a first surface adapted to face a body to be cleaned, and a plurality of supply openings and return openings on the first surface. At least a portion of the supply openings and return openings are positioned as alternating rows of supply openings and return openings. The supply openings are larger in area than the return openings in at least a majority of the alternating rows. The supply openings and the return openings are adapted to transmit at least one of a gas and a liquid therethrough. The head structure is adapted to permit the transmission of at least one of a gas and a liquid through the supply openings and at the same time the head structure is also adapted to permit the transmission of at least one of a gas and a liquid through the return openings. Other embodiments are described and claimed.

### RELATED ART

Integrated circuits may be formed on semiconductor wafers made of materials such as silicon. The semiconductor wafers are processed to form various electronic devices. The wafers are diced into semiconductor chips (a chip is also known as a die), which may then be attached to a package substrate using a variety of known methods. During certain types of procedures, for example, testing, a thermal interface fluid may be placed onto a surface of an electronic device in order to control the temperature of the device during operations. After testing, it is desired to remove the interface fluid and foreign material that has accumulated on the surface of the electronic device. Such a removal process may be termed a de-application (or De-App) process.

### BRIEF DESCRIPTION OF THE DRAWINGS

Embodiments are described by way of example, with reference to the accompanying drawings, which are not drawn to scale, wherein:

FIG. 1 illustrates a view of a surface of a head that may be used for cleaning an electronic device surface in accordance with certain embodiments;

FIG. 2 illustrates a blown up view of the region B in FIG. 1, showing openings in the surface, in accordance with certain embodiments;

FIG. 3 illustrates a view of an intermediate level in a head structure, in accordance with certain embodiments;

FIG. 4 illustrates a view of an upper surface of a head structure, in accordance with certain embodiments;

FIG. 5 illustrates a cross-sectional view of an apparatus including an assembly of components including a head, a manifold, and a gasket, in accordance with certain embodiments;

FIG. 6 illustrates a portion of a head including supply and return openings positioned over a surface to be cleaned, and directions of flow, in accordance with certain embodiments;

FIG. 7 illustrates a cross-sectional view of a gasket structure positioned between a head and a device having a surface to be cleaned, in accordance with certain embodiments;

FIG. 8 illustrates a cross-sectional view of a gasket structure positioned between a head and a device having a surface to be cleaned, in accordance with certain embodiments;

FIG. 9 illustrates an arrangement of supply and return openings that may be positioned on a head, in accordance with certain embodiments; and

FIG. 10 illustrates a flow chart of process operations, in accordance with certain embodiments.

### DETAILED DESCRIPTION

The need for cleaning a surface of an electronic device may arise after an interface fluid is utilized on the surface. The interface fluid may act to collect foreign material on and upon evaporation or other removal of the interface material, a quantity of foreign material may remain on the surface in the form of stains. Certain embodiments relate to cleaning of an electronic device surface and removal of remaining interface fluid and foreign materials that have accumulated on the surface. This may be carried out using an apparatus including a head structure positioned adjacent to a surface to be cleaned.

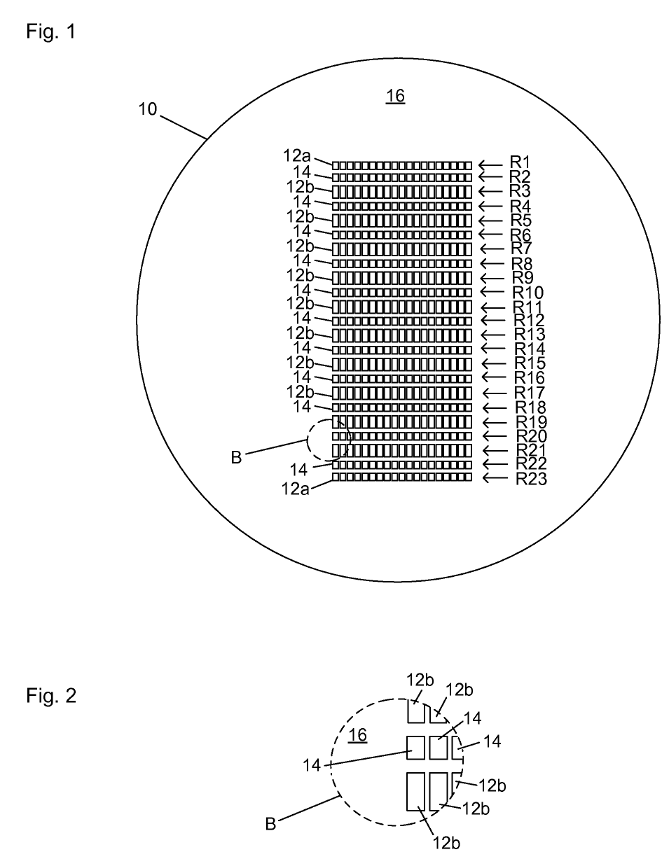

FIG. 1 illustrates a first surface 16 of a head 10 that may be used for cleaning an electronic device surface in accordance with certain embodiments. Examples of electronic device surfaces include, but are not limited to, a semiconductor die and a lid positioned to cover a semiconductor die in a package. As indicated by the arrows in FIG. 1, the surface 16 of the head 10 includes a plurality of rows R1-R23 of openings 12a, 12b, and 14. As illustrated in FIG. 1, the uppermost and lowermost rows R1 and R23 include openings 12a. Between the rows R1 and R23 are alternating rows of openings 14 and openings 12b. The openings 12a, 12b, and 14 are used to transmit gas and fluid to the surface to be cleaned and to remove the gas, fluid, and foreign material from the surface to be cleaned.

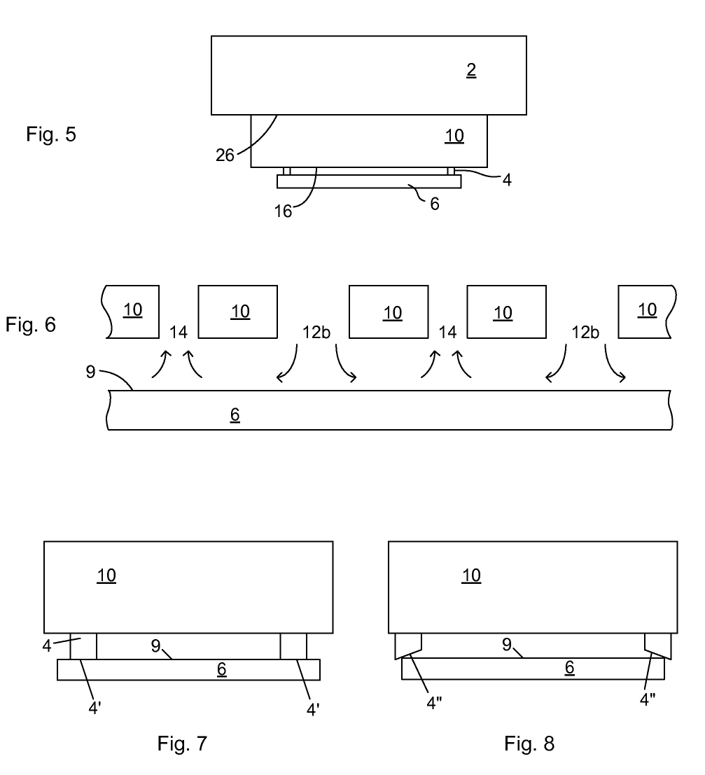

In accordance with certain embodiments, the head 10 may be used together with several other components as illustrated in FIG. 5, in order to clean a surface of an electronic device 6. The head 10 is positioned below a manifold 2. The manifold 2 is a structure that directs and receives gas and liquid to and from the head 10. A gasket 4 may be positioned between the head 10 and the electronic device 6. The gasket 4 acts to form a seal between the head 10 and the device 6, to form a closed region on the surface to be cleaned by inhibiting the flow of gas and liquid off of the sides of the surface to be cleaned on the device 6.

As noted above, the openings 12a, 12b, and 14 illustrated in FIG. 1 are used to transmit gas and fluid to the surface to be cleaned and to remove the gas, fluid, and foreign material from the surface to be cleaned. In the embodiment of FIG. 1, the rows alternate between supply openings and return openings. By supply openings it is meant that these openings supply gas and/or liquid to the surface to be cleaned. By return openings it is meant that these openings are used to remove the supply gas and/or liquid and any foreign material from the surface to be cleaned. The supply openings include openings 12a and 12b. The difference between the openings 12a and 12b is that the 12a openings are smaller than the 12b openings. In this embodiment, only the end rows (top and bottom as illustrated in FIG. 1) of openings are the smaller openings 12a. The rest of the supply openings are the larger openings 12b. The return openings include the openings 14. These openings are smaller than the supply openings 12b. The relative size of the openings 12b and 14 of FIG. 1 can be seen more clearly in FIG. 2, which is an expanded up view of a portion B of the surface 16 of the head 10.

The openings may take a variety of shapes, including, but not limited to, rectangular, round, and oval. The embodiment illustrated in FIG. 1 includes openings that are substantially rectangular in shape. In certain embodiments the openings may include length and width dimensions ranging from 100 microns to 1000 microns. Other embodiments may include length and width dimensions ranging from 200 microns to 800 microns. One specific example of sizes of the openings 12a, 12b, and 14 in FIG. 1 includes length and width dimensions of 450 microns by 350 microns for the openings 12a and 14, and 740 microns×350 microns for the openings 12b.

FIG. 6 illustrates a portion of the head 10 and a surface to be cleaned on device 6 and includes arrows showing the direction of flow of fluid (for example, gas and/or liquid) from the supply openings 12b to the return openings 14. FIG. 6 shows two supply openings 12b and two return openings 14. As indicated by the arrows, a fluid flows through the head and through the supply openings 12b and is directed towards the surface to be cleaned 9 on the device 6. The fluid contacts the surface 9 and is then drawn towards the return openings. Foreign material on the surface 9 will be impacted by the fluid and removed from the surface 9 through the return openings 14.

In certain embodiments, the distance between the surface to be cleaned and the head surface containing the supply and return openings is no greater than about 1000 microns. It has been found that the use of larger sized supply openings than return openings leads to better cleaning. This is believed to be due to the ability to generate relatively high shear stresses and high gas velocity through the supply openings, across the surface to be cleaned, and back through the return openings in the head. In addition, the use of a relatively large number of openings spaced close to the surface to be cleaned has been found to be more effective than using fewer openings spaced further apart from one another. Having a large number of openings minimizes the presence of stagnation zones (where there is little flow across a portion of the surface to be cleaned).

The head structure 10 may be formed to include a plurality of layers including paths that lead from the top surface of the head 10 that is coupled to the manifold 2, to the bottom surface of the head that includes the surface having the supply and return openings and which faces the surface to be cleaned, as illustrated in FIG. 5. These paths act to guide the flow of gas, liquid, and other materials towards the surface to be cleaned and away from the surface to be cleaned.

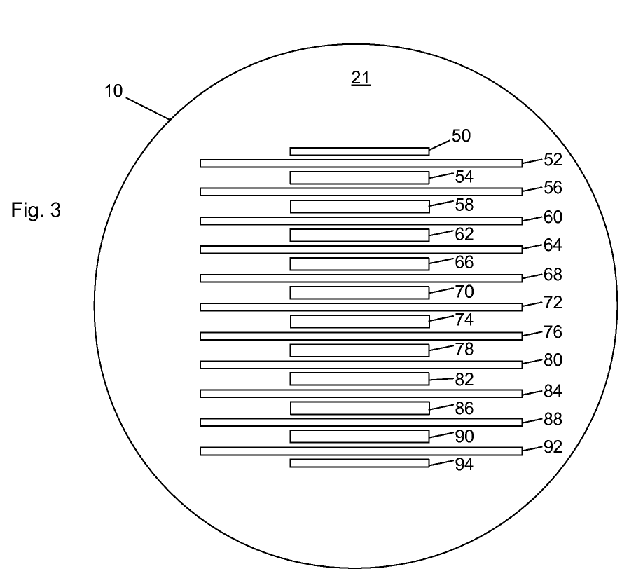

FIG. 3 illustrates an intermediate level 21 in the head structure between the head surface 16 adjacent to the surface to be cleaned and the head surface 26 adjacent to the manifold 2. The intermediate level 21 in the head 10 includes a number of slots of alternating width. As illustrated in FIG. 3, slots 50, 54, 58, 62, 66, 70, 74, 78, 82, 86, and 90 are positioned over and in communication with the supply openings 12a or 12b in corresponding rows R1, R3, R5, R7, R9, R11, R13, R15, R17, R19, R21, and R23 of FIG. 1. Likewise, the slots 52, 56, 60, 64, 68, 72, 76, 80, 84, 88, and 92 are positioned over and in communication with the return openings R2, R4, R6, R8, R10, R12, R14, R16, R18, R20, and R22 of FIG. 1. From the surface 16 to the intermediate level 21 in the head 10, each row of the supply openings 12a, 12b and return openings 14 is in communication with a corresponding slot.

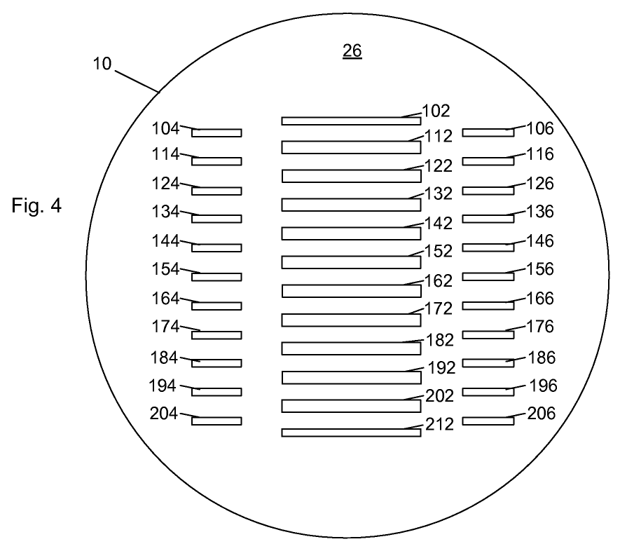

FIG. 4 illustrates the top surface 26 of the head 10. This top surface 26 is adjacent to the manifold 2 as illustrated in FIG. 5. A plurality of slots are positioned at this top surface 26 (upper level) of the head 10. The slots at this surface 26 are configured in alternating rows of one intermediate length slot (positioned in communication with a row of supply openings) and two short slots (in communication with a row of return openings), with the slots all spaced a larger distance apart at this surface than at the intermediate level 21. Such spacing may make it easier to provide proper alignment between the manifold and head for transmission of gas, fluid, etc. therebetween. These slots will be in communication with the corresponding slots therebelow and in communication with the manifold 2. Slots 102, 112, 122, 132, 142, 152, 162, 172, 182, 192, 202, and 212 are positioned over and in communication with slots 50, 54, 58, 62, 66, 70, 74, 78, 82, 86, 90, and 94. Slots 104 and 106 are relatively short slots and are positioned over and in communication with slot 52.

Similarly, slots 114 and 116 are positioned over and in communication with slot 56, slots 124 and 126 are positioned over and in communication with slot 60, slots 134 and 136 are positioned over and in communication with slot 64, slots 144 and 146 are positioned over and in communication with slot 68, slots 154 and 156 are positioned over and in communication with slot 72, slots 164 and 166 are positioned over and in communication with slot 76, slots 174 and 176 are positioned over and in communication with slot 80, slots 184 and 186 are positioned over and in communication with slot 84, slots 194 and 196 are positioned over and in communication with slot 88, and slots 204 and 206 are positioned over and in communication with slot 92.

As illustrated in FIG. 5, the gasket 4 acts to form a closed system and inhibit the flow of supply and return materials off of the sides of the surface being cleaned. Depending on the size and shape of the surface to be cleaned, a variety of gasket configurations may be used. For example, in certain embodiments, the gasket may sit on a flat outer portion of a surface to be cleaned. In another embodiment, the gasket includes an angled surface which is designed to engage the upper edges of the surface to be cleaned. FIG. 7 illustrates an embodiment in which a gasket 4 positioned between a head 10 and device 6 is positioned to engage a portion of the upper surface 9 to be cleaned on the device 6. The gasket 4 includes an end region 4′ having a flat surface that is positioned on the surface 9. FIG. 8 illustrates and embodiment in which a gasket includes an angled end region 4″ that is configured to engage a corner edge region of the device 6. This is carried out by forming the gasket to include an angled surface, for example, 30° from horizontal.

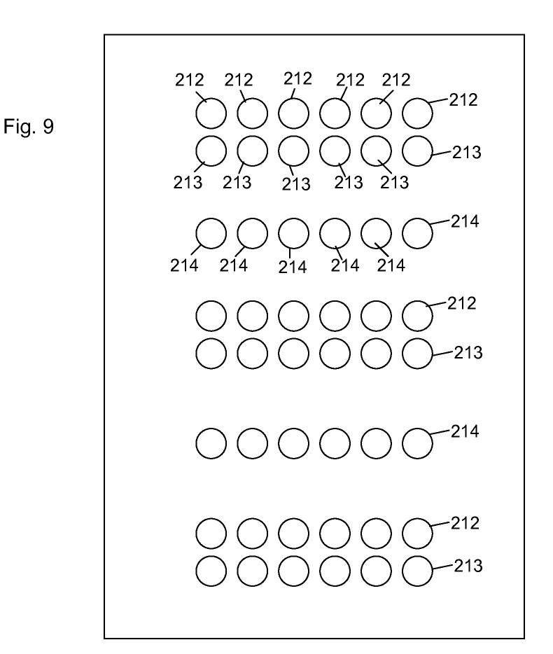

FIG. 9 illustrates an example of a configuration of openings 212, 213, 214 that may be used on the surface of a cleaning head. In practice more rows and more openings may be present but this view is intended to show the relative positioning of the rows and shape of the openings. In this embodiment the openings 212, 213, 214 are all round in shape. The openings are arranged in rows and include two rows spaced close to one another and then one row spaced further apart. The pattern repeats itself, with an alternating pattern of two closely spaced rows of openings (one row includes openings 212 and the second includes openings 213) and one further spaced apart row of openings 214. In certain embodiments, the openings 212 and 213 in the closely spaced rows act as supply openings, and the openings 214 in the spaced apart row act as return openings. The openings 212, 213, and 214 may in certain embodiments be the same size, which may lead to advantages in manufacturing the head.

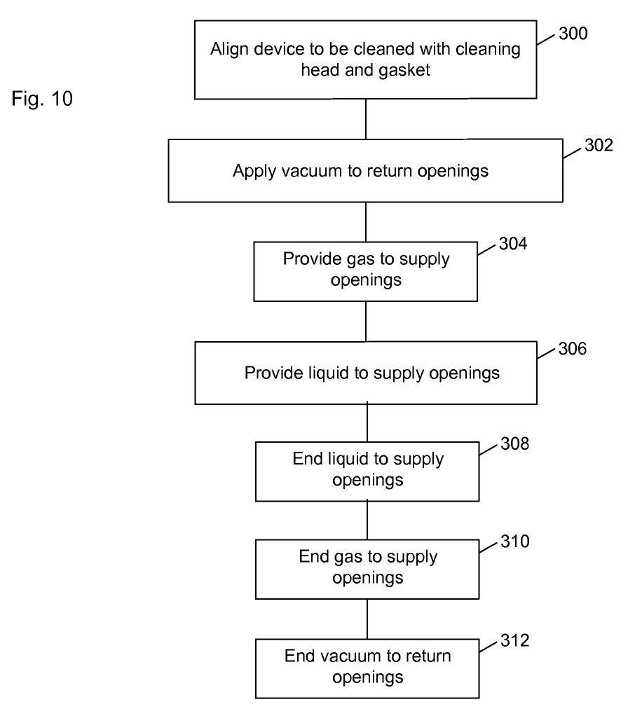

FIG. 10 illustrates a flowchart of operations, in accordance with certain embodiments. Box 300 is aligning a surface to be cleaned with the head and gasket. Box 302 is applying a vacuum to return openings in the head. Box 304 is providing gas (for example, air) to the supply openings in the head and in turn to the surface to be cleaned. Box 306 is providing a liquid (for example, distilled water) to the supply openings so that the liquid can be supplied to the surface to be cleaned. Box 308 is ending the supply of liquid to the supply openings. Box 310 is ending the flow of gas to the supply openings. Box 312 is ending the vacuum to the return openings.

In certain embodiments of a De-App process, the vacuum CFM flow may be between 0.8 and 4.0 CFM, with a vacuum pressure between 10 and 25 in of Hg. In certain embodiments, the air pressure may include and air CFM flow of between 0.8 and 4.0 CFM, and an air pressure of between 10 psi and 100 psi. In certain embodiments, the air temperature may be between 10° C. and 100° C. In certain embodiments, the total amount of liquid (for example, water) used during a De-App process may be between 0.1 cc and 5 cc. Another range of water use is between 0.3 cc and 2 cc of water. During one specific De-App process, the entire process takes approximately 4 seconds, with 0.5 seconds air flow through the supply openings, followed by 0.5 seconds of both air flow and distilled water flow, followed by 3 seconds of just air flow. Such a process may utilize a very small quantity of distilled water, for example, one or two drops. It is believed that the use of a liquid aids in stain removal. In certain embodiments, the additional of a liquid may not be necessary.

It should be appreciated that an assembly including a head structure such as described above may be used for not only cleaning operations but in certain embodiments may also be used during other operations, for example, to deliver and remove liquids and gases to a surface. For example, during certain testing procedures, a thermal interface material may be placed onto a device to control the temperature during testing and then removed after the testing. A head structure including supply openings and return openings may be used for carrying out such operations. After those operations are complete, the same head may be used to carry of a De-App operation to clean any staining off the device as described above.

Terms such as “above”, “below”, “first”, “second”, and the like as used herein to not necessarily denote any particular order, quantity, or importance, but are used to distinguish one element from another. Terms such as “top”, “bottom”, “upper”, and “lower” and the like as used herein refer to the orientation of features as illustrated in the attached figures. The term opening refers to an aperture or orifice through which a material may flow.

While certain exemplary embodiments have been described above and shown in the accompanying drawings, it is to be understood that such embodiments are merely illustrative and not restrictive. For example, the exact layout of openings and pathways through a head may vary from that described above. Embodiments are not restricted to the specific constructions and arrangements shown and described since modifications may occur to those having ordinary skill in the art.

What is claimed:

1. An apparatus to clean an electronic device comprising:
a head structure including a first surface adapted to face a body to be cleaned;
a plurality of supply openings and a plurality of return openings on the first surface;
at least a portion of the supply openings and return openings positioned as alternating rows of supply openings and return openings on the first surface;
the supply openings being larger in area than the return openings in at least a majority of the alternating rows of supply openings and return openings;
wherein the supply openings are adapted to transmit at least one of a gas and a liquid therethrough;
wherein the return openings are adapted to transmit at least one of a gas and a liquid therethrough; and
wherein the head structure is adapted to permit the transmission of at least one of a gas and a liquid through the supply openings and at the same time the head structure is also adapted to permit the transmission of at least one of a gas and a liquid through the return openings.

2. The apparatus of claim 1, wherein supply openings and the return openings have a width in the range of 100 to 1000 microns.

3. The apparatus of claim 1, wherein the supply openings and the return openings have a width in the range of 200 to 800 microns.

4. The apparatus of claim 1, wherein the supply openings and the return openings are generally rectangular in shape.

5. The apparatus of claim 1, wherein the supply opening and the return openings are arranged to define a shape selected from the group consisting of a square array of openings and a rectangular array of openings on the first surface.

6. The apparatus of claim 1, further comprising a gasket positioned to contact the first surface and to contact the surface to be cleaned, the gasket positioned to surround at least a portion of the surface to be cleaned and inhibit the flow of gas and liquid.

7. The apparatus of claim 6, the gasket includes an angled surface region relative to the surface to be cleaned, the angled surface region adapted to contact an outer edge of the surface to be cleaned.

8. The apparatus of claim 6, further comprising a manifold adapted to transmit gas and liquid through the head towards the surface to be cleaned and away from the surface to be cleaned.

9. The apparatus of claim 1, wherein the supply openings on the first surface are in communication with a supply path through the head, and wherein the return openings on the first surface are in communication with a return path through the head, wherein the supply path and the return path are independent of one another.

10. A method for cleaning a material from a surface of an electronic device, comprising:
providing a head structure including a first surface facing a surface to be cleaned on the electronic device, the first surface including a plurality of supply openings and a plurality of return openings, at least a portion of the supply openings and return openings positioned as alternating rows of supply openings and return openings on the first surface, the supply openings being larger in area than the return openings in a majority of the alternating rows of supply openings and return openings;
transmitting a gas through the supply openings so that the gas contacts the surface to be cleaned;
removing the gas from the surface to be cleaned through the return openings;
transmitting a liquid through the supply openings so that the liquid contacts the surface to be cleaned; and
removing the liquid from the surface to be cleaned through the return openings;
wherein a quantity of foreign material on the surface to be cleaned is removed from the surface to be cleaned through the return openings during the removing the gas and the removing the liquid through the supply openings.

11. The method of claim 10, further comprising performing the transmitting a liquid and the removing the liquid during the transmitting a gas and the removing the gas.

12. The method of claim 11, further comprising performing the transmitting a liquid and the removing the liquid for less time than the transmitting a gas and the removing the gas.

13. The method of claim 10, further comprising positioning the first surface and the surface to be cleaned to be no further than 1 mm from each other.

14. The method of claim 10, further comprising utilizing air as the gas and utilizing water as the liquid.

15. The method of claim 11, further comprising performing the transmitting a gas for a time including:
a first time period during which there is no transmitting of the liquid;
a second time period during which there is transmitting of the liquid; and
a third time period during which there is no transmitting of the liquid.

16. The method of claim 15, wherein the third time period is greater than the first and second time periods.

17. An apparatus to clean an electronic device comprising:
a head structure including a first surface adapted to face a body to be cleaned;
a plurality of supply openings and a plurality of return openings on the first surface, the supply openings and the return openings arranged as rows on the first surface;
wherein at least a majority of the rows are arranged to includes a two rows of supply openings adjacent to each other and then a row of return openings, followed again by two rows of supply openings adjacent to each other and then a row of return openings adjacent to one of the rows of supply openings, wherein a distance between the two rows of supply openings adjacent to each other is less than the distance between the row of return openings adjacent to the row of supply openings;
wherein the supply openings are adapted to transmit at least one of a gas and a liquid therethrough;
wherein the return openings are adapted to transmit at least one of a gas and a liquid therethrough;
wherein the head structure is configured to permit transmission of at least one of a gas and a fluid through the supply openings and the transmission of at least one of a gas and a liquid through the return openings at the same time.

18. The apparatus of claim 17, wherein supply openings and the return openings have a width in the range of 100 to 1000 microns.

19. The apparatus of claim 17, wherein the supply openings and the return openings are generally circular in shape.

20. The apparatus of claim 17, wherein the supply openings and the return openings have the same width on the first surface.
